(19) United States
(12) Patent Application Publication
(10) Pub. No.: US 2012/0242763 A1
(43) Pub. Date: Sep. 27, 2012

(54) INK-JET HEAD

(76) Inventors: Hao Jan MOU, Hsin-Chu (TW); Ta Wei Hsueh, Hsin-Chu (TW); Ying Lun Chang, Hsin-Chu (TW); Rong Ho Yu, Hsin-Chu (TW); Hsien Chung Tai, Hsin-Chu (TW); Cheng Ming Chang, Hsin-Chu (TW); Wen Hsiung Liao, Hsin-Chu (TW); Yung Lung Han, Hsin-Chu (TW)

(21) Appl. No.: 13/311,081

(22) Filed: Dec. 5, 2011

(30) Foreign Application Priority Data
Mar. 23, 2011 (CN) 201110080632.X

(51) Int. Cl. B41J 2/175

(52) U.S. Cl. 347/87

(57) ABSTRACT

The present invention related to an ink-jet head, adaptive for an ink cartridge including two ink tanks, the ink-jet head includes: a nozzle board, having a plurality of nozzles; and an ink-jet chip, being used for controlling the ink-jetting and having a total area region consisting of a length and a width, wherein the total area region includes: a non-wiring region, where two ink flow channels being installed therein; and a wiring region, where an internal circuit being installed therein; wherein the internal circuit includes a plurality of ink-jet unit sets, and every ink-jet units of the plurality of ink-jet unit sets include a heater installed correspondingly to the nozzle; wherein the area of the wiring region of the ink-jet chip is less than 77% of the area of the total area region of the ink-jet chip.

### CROSS REFERENCE TO RELATED APPLICATION

This application claims the benefits of the China Patent Application Serial Number 201110080632.X, filed on Mar. 23, 2011, the subject matter of which is incorporated herein by reference.

### BACKGROUND OF THE INVENTION

1. Field of the Invention

The present invention relates to an ink-jet head and, more particularly, to an ink-jet head adaptive for the single-color ink-jet printing or the multi-colors ink-jet printing.

2. Description of Related Art

In the present ink-jet printing field, the best and most effective way for improving the printing resolution and increasing the printing speed is to increase the number of the heating elements on the ink-jet chip directly, i.e. increasing the number of nozzles. In addition, the conventional method for controlling the operation of the heating element, the heating elements are controlled by the control contacts in the one-on-one manner.

Please refer to FIG. 1, wherein FIG. 1 is a schematic view displaying the conventional circuit architecture for controlling the heating element to execute the heating operation. As shown in FIG. 1, the heating element 10 is connected between a driving control terminal 11 and a switch element 12, wherein the driving control terminal 11 receives a voltage signal P. The switch element 12 is connected between a control contact 13 and a ground terminal 14, wherein the control contact 13 receives an address signal A, for controlling the switch element 12 to be in the On-state or in the Off-state. For example, when the address signal A received by the control contact 13 is in the relative logic “High” state, the switch element 12 is in the On-state. At this time, the voltage signal P provides an electric energy to the heating element 10, making the ink flowing through the heating element 10 to be ink-jetted to a printing media, through the corresponding nozzle (not shown in the figure). On the contrary, when the address signal A received by the control contact 13 is in the relative logic “Low” state, the switch element 12 is in the Off-state. At this time, the voltage signal P stops to provide the electric energy to the heating element 10, making the heating element 10 unable to execute the heating process. Thus, the ink-jetting operation is terminated.

However, in the above-mentioned method for controlling the operation of the heating elements, the number of the heating elements must be increased for improving the printing resolution and increasing the printing speed, resulting in the increasing of the number of the control contacts, in order to control the operation of every heating elements. For example, when the number of the address signals A, for controlling the operation of the heating elements, is 20, there are 20 control contacts required to be installed correspondingly. As a result, the area of the total wiring region of the ink jet chip (not shown in the figure) is increased, resulting in the increasing of the area of the total installing region of the ink-jet chip. Thus, the manufacturing cost of the ink-jet chip is increasing accordingly. In the above-mentioned ink-jet chip, the wiring region is the region of the ink-jet chip, after the region of the ink flow channel being excluded.

Moreover, for achieving the purpose of decreasing the number of the control contacts, a method for controlling the operation of the heating elements, adopting a plurality of N-MOS elements, has been proposed. However, if the number of the heating elements required by the method is increasing, more control contacts are still required to be installed. For this reason, another method for controlling the operation of the heating elements, adopting a plurality of C-MOS elements, has also been proposed. However, the manufacturing cost of the C-MOS element is much higher than that of the N-MOS element, which is not favorable in the widely application in the industry.

Therefore, it is desirable to provide an improved ink-jet head to mitigate and/or obviate the afore-mentioned problems.

### SUMMARY OF THE INVENTION

The object of the present invention is to provide an ink-jet head, capable of controlling more ink-jet units with fewer control contacts, and lowering the percentages of the area of the wiring region over the total area region of the ink-jet chip. In addition, by arranging the heaters interleavingly, the resolution of the ink-jet head can be increased. Thus, the area of the ink-jet chip can be reduced significantly, enabling the ink-jet chip to be more miniaturizing, and decreasing the manufacturing cost of the ink-jet chip.

To achieve the object, in one broader aspect of the present invention, an ink-jet head is provided, which is adaptive for an ink cartridge including two ink tanks, the ink-jet head includes: a nozzle board, having a plurality of nozzles; and an ink-jet chip, being used for controlling the ink-jetting and having a total area region consisting of a length and a width, wherein the total area region includes: a non-wiring region, where two ink flow channels being installed therein; and a wiring region, where an internal circuit being installed therein; wherein the internal circuit includes a plurality of ink-jet unit sets, and every ink-jet units of the plurality of ink-jet unit sets include a heater installed correspondingly to the nozzle; wherein the area of the wiring region of the ink-jet chip is less than 77% of the area of the total area region of the ink-jet chip.

To achieve the object, in another broader aspect of the present invention, an ink-jet head is provided, which is adaptive for an ink cartridge including two ink tanks, the ink jet head includes: a nozzle board, having a plurality of nozzles; and an ink-jet chip, being used for controlling the ink-jetting and having a total area region consisting of a length and a width, wherein the total area region includes: a non-wiring region, where two ink flow channels being installed therein; and a wiring region, where an internal circuit being installed therein; wherein the internal circuit includes a plurality of ink-jet unit sets, and every ink-jet units of the plurality of ink-jet unit sets include a heater installed correspondingly to the nozzle; each of the plurality of ink-jet unit sets includes: a first ink-jet unit, for receiving a voltage signal, a plurality of address signals, and a selection signal; and a second ink-jet unit, for receiving the voltage signal and the plurality of address signals; when the selection signal is in the enable state, the first ink-jet unit enables the heater thereof to execute the heating operation, corresponding to the voltage signal and the plurality of address signals; when the selection signal is in the disable state, the second ink-jet unit enables the heater thereof to execute the heating operation, corresponding to the voltage signal and the plurality of address signals; wherein the area of the wiring region of the ink-jet chip is less than 77% of the area of the total area region of the ink-jet chip.

### BRIEF DESCRIPTION OF THE DRAWINGS

FIG. 1 is a schematic view displaying the conventional circuit architecture for controlling the heating element to execute the heating operation.

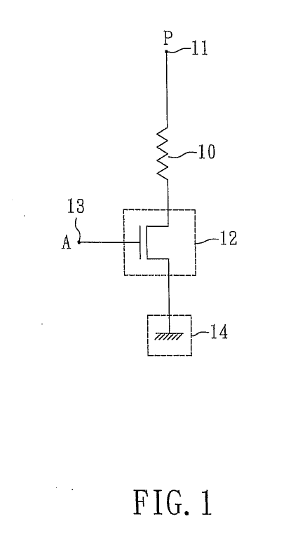

FIG. 2A is a cross-sectional view of the ink cartridge, according to one preferred embodiment of the present invention.

FIG. 2B is a schematic view displaying the structure of a single-color ink-jet head according to the first embodiment of the present invention.

FIG. 2C is a schematic view displaying the structure of the single-color ink-jet head, after the nozzle board of FIG. 2B having been removed.

FIG. 3A is a schematic view displaying the structure of a multi-colors ink-jet head according to the second embodiment of the present invention.

FIG. 3B is a schematic view displaying the structure of the multi-colors ink-jet head, after the nozzle board of FIG. 3A having been removed.

FIG. 3C is a schematic view displaying the structure of the multi-colors ink-jet head, after portions the nozzle board of FIG. 3A having been removed.

FIG. 4 is a schematic view displaying the connecting architecture between the ink-jet control circuit of an ink-jet printer and the ink-jet chip.

FIG. 5 is a schematic view displaying the circuit block of one of the plurality of ink-jet unit sets of FIG. 4.

FIG. 6A is a schematic view displaying the architecture of the internal circuit of the ink-jet unit set of FIG. 5.

FIG. 6B is a schematic view displaying the timing diagram of the signals in the forward direction, when the electric circuit of the ink-jet unit set of FIG. 6A is operating.

FIG. 6C is a schematic view displaying the timing diagram of the signals in the reversed direction, when the electric circuit of the ink-jet unit set of FIG. 6A is operating.

FIG. 7A is a schematic view displaying the other architecture of the internal circuit of the ink-jet unit set of FIG. 5

FIG. 7B is a schematic view displaying the timing diagram of the signals in the forward direction, when the electric circuit of the ink-jet unit set of FIG. 7A is operating.

FIG. 7C is a schematic view displaying the timing diagram of the signals in the reversed direction, when the electric circuit of the ink-jet unit set of FIG. 7A is operating.

FIG. 8A is a schematic view displaying the block diagram of the ink-jet array, according to one preferred embodiment of the present invention.

FIG. 8B is a schematic view displaying the extended circuit architecture of FIG. 6A.

FIG. 8C is a schematic view displaying the extended circuit architecture of FIG. 7A.

FIG. 9A is a schematic view displaying the tuning diagram of the address signals in the first printing direction according to one embodiment of the present invention.

FIG. 9B is a schematic view displaying the timing diagram of the address signals in the second printing direction according to one embodiment of the present invention.

### DETAILED DESCRIPTION OF THE PREFERRED EMBODIMENT

Other objects, advantages, and novel features of the invention will become more apparent from the following detailed description when taken in conjunction with the accompanying drawings. The description and the drawing in the specification of the present invention are essentially used for explanation only; they are not supposed to be used for limiting the scope of the present invention.

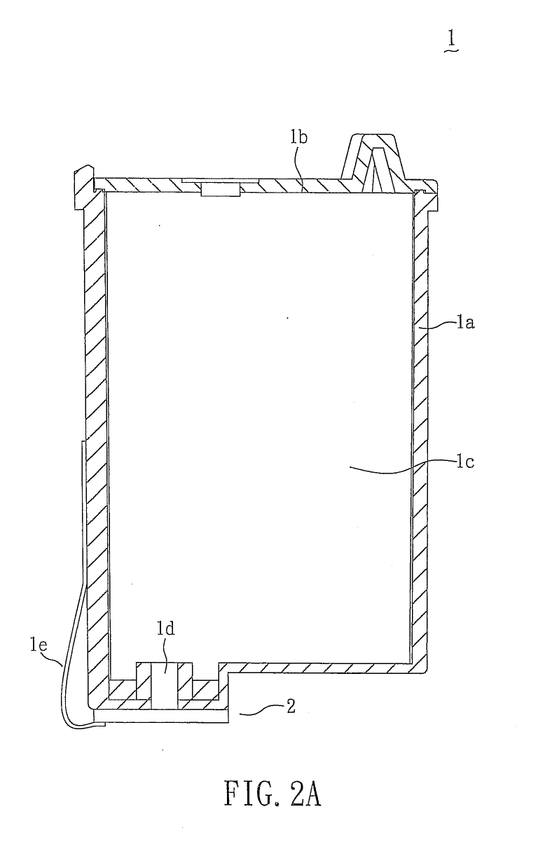

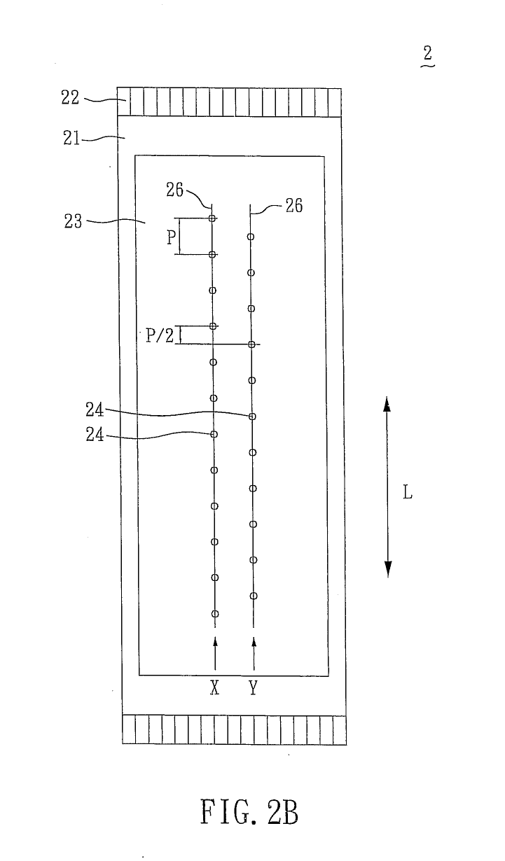

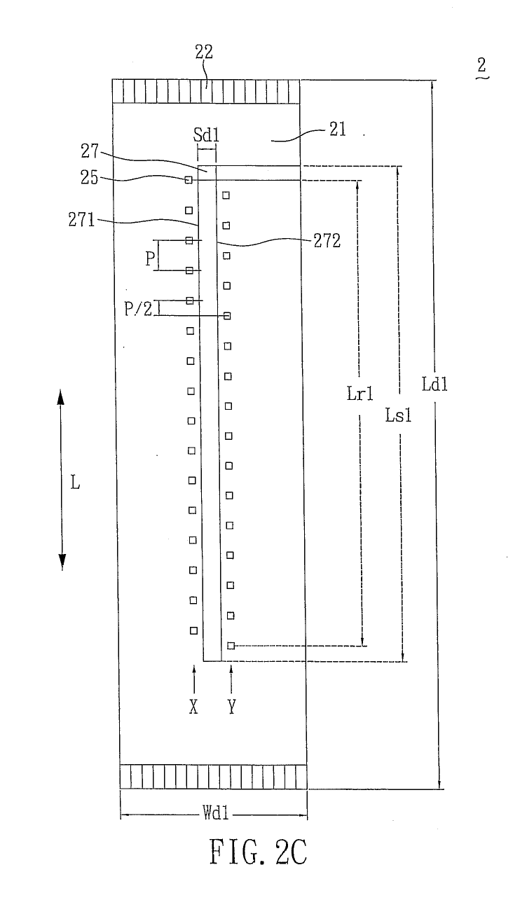

Please refer to FIG. 2A, which is a cross-sectional view of the ink cartridge, according to one preferred embodiment of the present invention. As shown in FIG. 2A, an ink cartridge 1 is consist of a body 1a and a cover 1b, wherein the body 1a and the cover 1b are used to define at least one ink tank 1c, such as a mono-ink-tank, a bi-ink-tanks, or a tri-ink-tanks, for storing ink therein. The ink can be introduced to an ink flow channel of an ink-jet head 2 (not shown in the figure) through the ink supply passage 1d installed on the body 1a. The ink cartridge 1 further comprises a soft electric circuit carrier 1e, wherein one side of the soft electric circuit carrier 1e is connected with an electric connecting plate of the ink-jet head 2 (not shown in the figure). In addition, a plurality of metal contacts (not shown in the figure) is formed on the other side of the soft electric circuit carrier 1e, which is extended curvedly and attached to one side of the body 1a. The soft electric circuit carrier 1e is used for making the ink-jet control circuit of an ink-jet printer (not shown in the figure) to be connected with the ink-jet head 2. The ink cartridge 1 receives the control signal of the ink-jet control circuit, through the plurality of metal contacts of the soft electric circuit carrier 1c, and then actuates in response to the control signal.

Please refer to FIG. 2B, which is a schematic view displaying the structure of a single-color ink-jet head according to the first embodiment of the present invention. The structure of the ink-jet head 2 shown in FIG. 2B is in a simplified form. In the present embodiment, the ink-jet head 2 is in a strip form and including: an ink-jet chip 21, an electric connecting plate 22, and a nozzle board 23, wherein the electric connecting plate 22 is installed on the ink-jet chip 21. In addition, a plurality of heaters 25 is installed on the surface of the ink-jet chip 21 (as shown in FIG. 2C), and the nozzle board 23 includes a plurality of nozzles 24 corresponding to the heaters 25. In the present embodiment, the number of the nozzles can be at least 750, making the number of the heaters to be at least 750, accordingly. However, the number of the nozzles and the number of the heaters are not limited to the value (750) mentioned above. In the present embodiment, the composite nozzle resolution of the ink-jet head 2 can be 1200 dots per inch (dpi). That is, the effective ink-jet distance of the ink-jet head 2, measured along with a reference axis L, is 1/1200 inch. For achieving the high resolution printing, the nozzles 24 of the ink jet head 2 can be arranged to form a combination of axes, which includes 2 rows of axis, i.e. the row X and row Y in the figure. The row X and the row Y have their own centerline 26, respectively. The two centerlines 26 are parallel with each other, and further are parallel with the reference axis L. In addition, the nozzles 24 in the row X and the nozzles 24 in the row Y are arranged interleavingly. The distance between two nozzles on the same centerline 26, is P, while the perpendicular distance between two nozzles on different centerlines 26 is P/2. In the present embodiment, P can be 1/600 inch, while the P/2 can be 1/1200 inch. However, the values of P and P/2 are not limited to the values mentioned above.

Please refer to FIG. 2C, which is a schematic view displaying the structure of the single-color ink-jet head, after the nozzle board of FIG. 2B having been removed. As shown in the figure, the ink-jet chip 21 of the ink-jet head 2 is in a rectangular form. The aspect ratio of the ink-jet chip 21 is preferably in the range between 11 and 20. Both of the length Ls1 of the center ink flow channel 27 and the length of the region where the heaters locate Lr1 can be varied, according to the resolution of the ink-jet head 2 and the number of the heaters 25 selected by a designer. In the present embodiment, the width of the ink-jet chip 21 (Wd1) is about 1.27˜2.31 mm, while the length of the ink-jet chip 21 (Ld1) is about 25.4 mm, resulting in the area of the ink-jet chip 21 to be about 32.258˜58.674 mm². As a result, when the number of the nozzles 24 of the ink-jet head 2 is at least 750, there are 750/58.674≈13˜750/32.258≈23 nozzles (not shown in the figure) per mm² formed on the nozzle board 23. That is, the resolution of the ink-jet head 2 (number of heaters per mm²) is about 13˜23 heaters 25. Besides, these heaters 25 of the ink-jet chip 21 ink-jets the ink through the nozzles 24 arranged interleavingly. In addition, each row for locating the heaters 25 includes 375 nozzles 24.

Please refer to FIG. 2C again, a center ink flow channel 27 in the strip form and heaters 25 locating on one side or both sides of the center ink flow channel 27 are formed on the surface of the ink-jet chip 21. In the present embodiment, the case that the heaters 25 locating on both sides of the center ink flow channel 27 is taken as an example. In addition, a first longitudinal edge 271 of the heaters 25 in the row X is on one side of the center ink flow channel 27, while a second longitudinal edge 272 of the heaters 25 in the row Y is on the other side of the center ink flow channel 27. In the present embodiment, the width of the center ink flow channel 27 Sd1 can be 0.497˜0.562 mm, and the length of the center ink flow channel 27 (Ls1) can be 21.24 mm. In addition, after excluding the area of the center ink flow channel 27 from the total area of the ink-jet chip 21, the remaining region of the ink-jet chip 21 is the wiring region of the ink-jet chip 21. The remaining region of the ink-jet chip 21 is the region for installing the internal circuit thereon.

Since the heaters 25 are installed on the ink-jet chip 21 of a highly compact ink-jet head 2, the density of the heaters 25 on the ink-jet chip 21 must be greater than 10 heaters per mm², in order to make the cost of this highly compact ink-jet head 2 to be lower than that of ink-jet heads 2 having fewer nozzles 24 thereon. In the present embodiment, the ink-jet chip 21 has 13˜23 heaters 25 per mm², resulting in the total number of heaters 25 to be between 760 and 1350. However, the total number of the heaters 25 is preferably to be 1000. In this case, the density of heater 25 on the ink-jet chip 21 is to be 1000/(25.4×1.27)≈31˜1000/(25.4×2.31)≈17 heaters per mm².

In the present invention, the ratio of the area of wiring region of the ink-jet chip 21 over the total area region of the ink-jet chip 21 can be calculated by the formula listed below:

((total area of the ink-jet chip)−(the area of the ink flow channel non-wiring region))/(total area of the ink-jet chip)

In the present embodiment, the formula can be transformed into:

((the length of the ink-jet chip 21 Ld1×the width of the ink-jet chip 21 Wd1)−(the length of the center ink flow channel 27 Ls1×the width of the center ink flow channel 27 Sd1))/(the length of the ink-jet chip 21 Ld1×the width of the ink-jet chip 21 Wd1).

Since the area of the wiring region of the ink-jet chip 21 is about 20.32 mm² (25.4×1.27−0.497×21.24)˜48.11 mm² (25.4×2.31−0.562×21.24), the ratio of the area of wiring region of the ink-jet chip 21 over the total area region of the ink-jet chip 21 is about 20.32 mm²/32.258 mm²=63%˜48.11 mm²/58.67.4 mm²=82%. In the present embodiment, the width of the center ink flow channel 27 Sd1 is preferably in the range between 0.497 and 0.552 mm. The ratio of the area of wiring region of the ink-jet chip 21 over the total area region of the ink-jet chip 21 is preferably 20.32 mm²/32.258 mm²=63%˜46.939 mm²/58.674 mm²=80%.

In general, for achieving the high-speed printing goal with the low-weight ink drops, the heater 25 must be operated in a very high frequency. The ink-jet head 2 of the present invention provides the high-speed and high-resolution printing by means of combining the high ink-jet frequency and the heaters 25 arranged both in high density and interleavingly. The ink-jet frequency of the heater 25 of the ink-jet head 2 of the present invention is greater than 20 kHz. The preferable ink-jet frequency range of the heater 25 is between 22 kHz and 26 kHz. In the present embodiment, the heater 25 is operating with the ink jet frequency of 24 kHz.

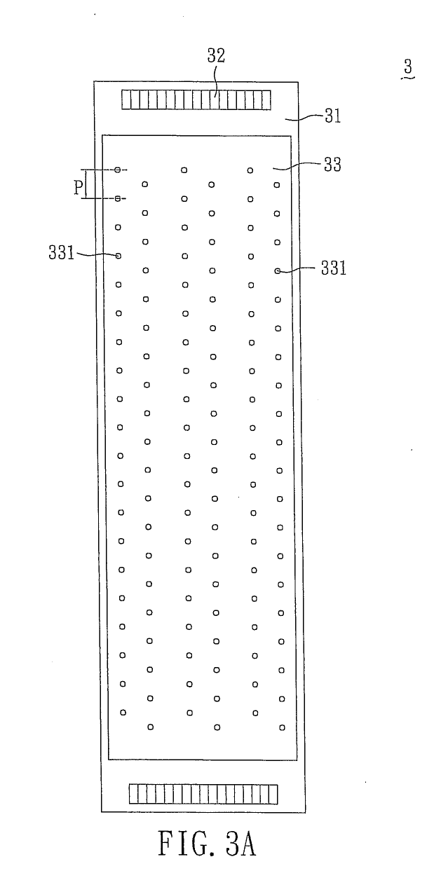

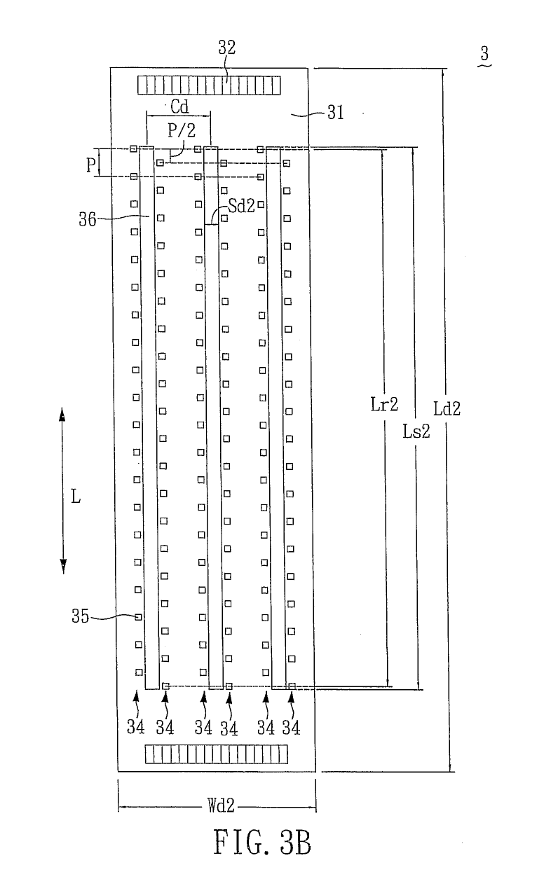

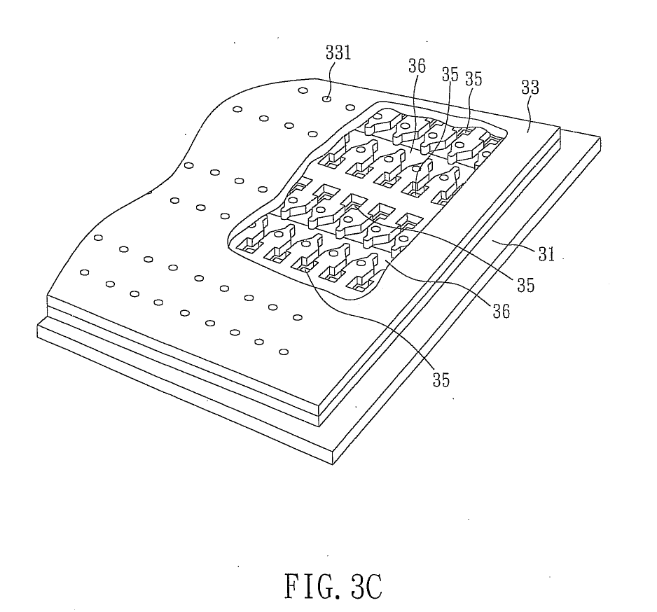

Please refer to FIG. 3A, which is a schematic view displaying the structure of a multi-colors ink-jet head according to the second embodiment of the present invention. The structure of the ink-jet head 3 shown in FIG. 3A is in a simplified form. In the present embodiment, the ink-jet head 3 is in a strip faith and including: an ink-jet chip 31, an electric connecting plate 32, and a nozzle board 33, wherein the electric connecting plate 32 is installed on the ink-jet chip 31. Besides, the ink-jet chip 31 includes a plurality of heaters 35 arranged in the form of 3 axis matrices 34 (as shown in FIG. 3B). In addition, the nozzle board 33 includes a plurality of nozzles 331 corresponding to the heaters 35, for providing multi-strips and multi-colors printing with a certain printing resolution. Moreover, the dot distance of the ink-jet media axis can be smaller than or equal to the spacing of the nozzles on the axis.

Please refer to FIG. 3B and FIG. 3C, wherein FIG. 3B is a schematic view displaying the structure of the multi-colors ink jet head, after the nozzle board of FIG. 3A having been removed, and FIG. 3C is a schematic view displaying the structure of the multi-colors ink-jet head, after portions the nozzle board of FIG. 3A having been removed. As shown in the figures, the heaters 35 are formed on the surface of the ink-jet chip 31, along with the axis matrices 34 being parallel with the reference axis L. Besides, the heaters 35 are separated with each other either in the direction parallel to the reference axis L or in the direction perpendicular to the reference axis L. In addition, taking the ink cartridge 1 of FIG. 2A as a basis, the ink cartridge 1 in the present embodiment can have 3 ink tanks 1c, for respectively storing ink of different colors therein. Corresponding to every ink tanks 1c, at least one ink flow channel 36 is installed on the ink-jet chip 31. The ink-jet chip 31 further has 3 ink flow channels 36, which are parallel with the reference axis L, for transmitting the ink of different colors, respectively. In the direction perpendicular to the reference axis L, these 3 ink flow channels 36 are separated with each other, for, providing the heaters 35 arranged in the 3 axis matrices 34 with ink of the same color or of different colors. Every axis matrices 34 can be composed of two rows of heaters, locating on two sides of the ink flow channel 36 and parallel with the reference axis L, in order to ink-jet the ink of same color. However, the composition of the axis matrix 34 and the orientation of the heaters 35 in the axis matrix 34 are not thus limited. Besides, the heaters 35 in the 2 rows are arranged interleavingly with each other, and located on two sides of the ink flow channel 36. Therefore, there are 6 rows of heaters (two rows for each of the 3 colors) arranged on the ink-jet chip 31 of the present embodiment.

In every axis matrices 34, 1500˜2000 heaters 35 can be included. In the present embodiment, every rows of the heater 35 can be consisted of 1500˜2000 heaters. Thus, the total number of the heaters 35 can be 4500˜6000. Besides, in every axis matrices 34, the distance between two nearby heaters 35 belonged to the same row is P, while the distance between two nearby heaters 35 belonged to different rows is P/2. In the present embodiment, P can be 1/600 inch, while the P/2 can be 1/1200 inch. However, in some embodiments, the distance between two nearby heaters 35 belonged to the same row can be 1/600 inch˜ 1/1200 inch, while the perpendicular distance between two nearby heaters 35 belonged to different rows can be 1/1200 inch˜ 1/2400 inch.

In the present embodiment, the ink-jet chip 31 of the ink-jet head 3 is in a rectangular form. The aspect ratio of the ink-jet chip 31 is preferably in the range between 6 and 20. The width of the ink-jet chip 31 (Wd2) is about 1.32˜4.5 mm, while the length of the ink-jet chip 31 (Ld2) is about 26.5 mm, resulting in the area of the ink-jet chip 31 is about 34.98˜119.25 mm². The aspect ratio of the ink-jet chip 31 is about (Ld2/Wd2):6(26.5/4.5)˜20(26.5/1.32). As a result, there are about 4500/119.25≈38˜6000/34.98≈170 nozzles 34 (not shown in the figure) per mm² formed on the nozzle board 33 of the ink-jet head 3 of the present invention. That is, the resolution of the ink-jet head 3 (number of heaters per mm²) is about 38˜170 heaters 35. Besides, these heaters 35 of the ink-jet chip 31 ink jet the ink through the nozzles 34 arranged interleavingly.

In addition, the width of every ink flow channels 36 (Sd2) is about 0.346˜0.875 mm, while the width of every ink flow channels 36 (Ls2) can be 12.8 mm. The length of the region where the heaters 35 locate Lr2 can be 12 mm, while the spacing between two nearby ink flow channels 36 (Cd) can be 1.27 mm. In some embodiments, the spacing between two nearby ink flow channels 36 (Cd) can be 1.27 mm, while the length of every ink flow channel 36 (Ls2) can be 12˜22 mm. In addition, after excluding the area of the 3 ink flow channels 36 from the total area of the ink-jet chip 31, the remaining region of the ink-jet chip 31 is the wiring region of the ink-jet chip 31. The remaining region of the ink-jet chip 31 is the region for installing the internal circuit thereon.

In the present invention, the ratio of the area of wiring region of the ink-jet chip 31 over the total area region of the ink-jet chip 31 can be calculated by the formula listed below:

((total area of the ink-jet chip)−(the area of the ink flow channel non-wiring region))/(total area of the ink-jet chip)

In the present embodiment, the formula can be transformed into:

((the length of the ink-jet chip 31 Ld2×the width of the ink-jet chip 31 Wd2)−(the length of the ink flow channel 36 Ls2×the width of the ink flow channel 36 Sd2)×(3 sets of ink flow channels 36))/(the length of the ink-jet chip 31 Ld2×the width of the ink-jet chip 31 Wd2).

Since the width of the ink flow channel 36 is 12.8 mm, while the width of the ink flow channel 36 is 0.346˜0.875 mm, the area of the wiring region is 21.69 mm² (26.5×1.32−12.8×0.346×3)˜85.65 mm² (26.5×4.5−12.8×0.875×3). Thus, the ratio of the area of wiring region of the ink-jet chip 31 over the total area region of the ink-jet chip 31 is about 21.69 mm²/34.98 mm²=62%˜85.65 mm²/119.25 mm²=72%.

In some embodiments, basing on the structure and the operation theory similar to those of the ink-jet head shown in FIG. 3A and FIG. 3B, when there are only 2 ink flow channels 36 on the ink-jet chip 31, and the width of every ink flow channels 36 can be 0.533˜4.072 mm, the ratio can be calculated by:

((the length of the ink-jet chip 31 Ld2×the width of the ink-jet chip 31 Wd2)−(the length of the ink flow channel 36 Ls2×the width of the ink flow channel 36 Sd2)×(2 sets of ink flow channels 36))/(the length of the ink-jet chip 31 Ld2×the width of the ink-jet chip 31 Wd2).

At this time, the area of the wiring region is 21.34 mm² (26.5×1.32−12.8×0.533×2)˜91.82 mm² (26.5×4.5−12.8×1.072×2). Thus, the ratio of the area of wiring region of the ink-jet chip 31 over the total area region of the ink-jet chip 31 is about 21.34 mm²/34.98 mm²=61%˜91.82 mm²/119.25 mm²=77%. In the present embodiment, the length of the ink flow channel 36 (Ls2) is preferably 12.8˜13.9 mm, then the ratio of the area of wiring region of the ink-jet chip 31 over the total area region of the ink-jet chip 31 is preferably 89.437 mm²/119.25 mm²=75%˜21.34 mm²/34.98 mm²=61%.

When the non-wiring region of the ink-jet chips 21, 31, i.e. the area of the ink flow channels 25, 36, is fixed, the total area of the ink-jet chips 21, 31 can be further reduced only if the wiring region of the ink-jet chips 21, 31, through the reduction on both the circuit installation area and the number of contacts of the ink-jet chips 21, 31. In this way, the size of the ink-jet head can be further reduced, resulting in the lowering of the manufacturing cost of the ink-jet head. In the following, the way to reduce the wiring region of the ink-jet chip will be described.

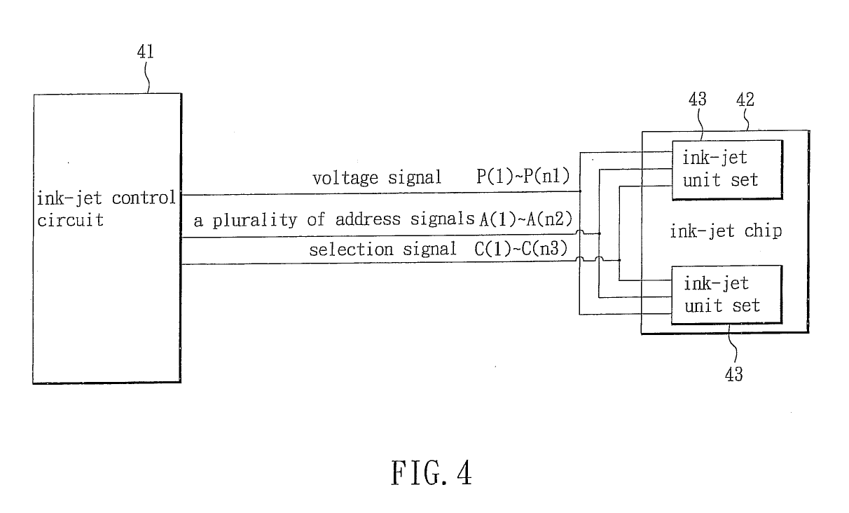

Please refer to FIG. 4, which is a schematic view displaying the connecting architecture between the ink-jet control circuit of an ink-jet printer and the ink-jet chip. As shown in FIG. 4, the internal circuit (i.e. the ink-jet control circuit) installed on the wiring region of the ink-jet chip 42 includes a plurality of ink-jet unit sets 43, wherein every ink-jet units of the plurality of ink-jet unit sets 43 include a heater (not shown in the figure). The heater is installed on the corresponding nozzle. When the ink-jet printer is operating, the ink-jet control circuit 41 of the ink-jet printer (not shown in the figure) transmits a plurality of voltage signals P(1)˜P(n1), a plurality of address signals A(1)˜A(n2), and a plurality of selection signals C(1)˜C(n3) to the plurality of ink-jet unit sets 43 of the ink-jet chip 42, for controlling the operation of the ink-jet head.

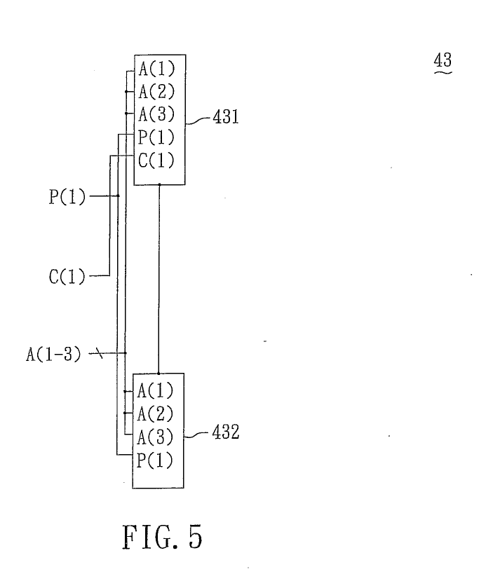

Please refer to FIG. 5, which is a schematic view displaying the circuit block of one of the plurality of ink-jet unit sets of FIG. 4. As shown in FIG. 5, the ink-jet unit sets 43 of the present invention at least includes a first ink-jet unit 431 and a second ink-jet unit 432, wherein the first ink-jet unit 431 receives a voltage signal P(1), and a plurality of address signals A(n−1), A(n), and A(n+1), and a selection signal C(1). For example, when n=2, the first ink-jet unit 431 receives the voltage signal P(1), the address signals A(1), A(2), and A(3), and the selection signal C(1). Besides, the second ink-jet unit 432 receives the voltage signal P(1), and the plurality of address signals A(1), A(2), and A(3). When the selection signal C(1) is in the enable state, such as in the relative logic “High” state, the first ink-jet unit 431 executes the heating operation in response to the voltage signal P(1) and the plurality of address signals A(1), A(2), and A(3). When the selection signal C(1) is in the disable state, such as in the relative logic “Low” state, the second ink-jet unit 432 executes the heating operation in response to the voltage signal P(1) and the plurality of address signals A(1), A(2), and A(3).

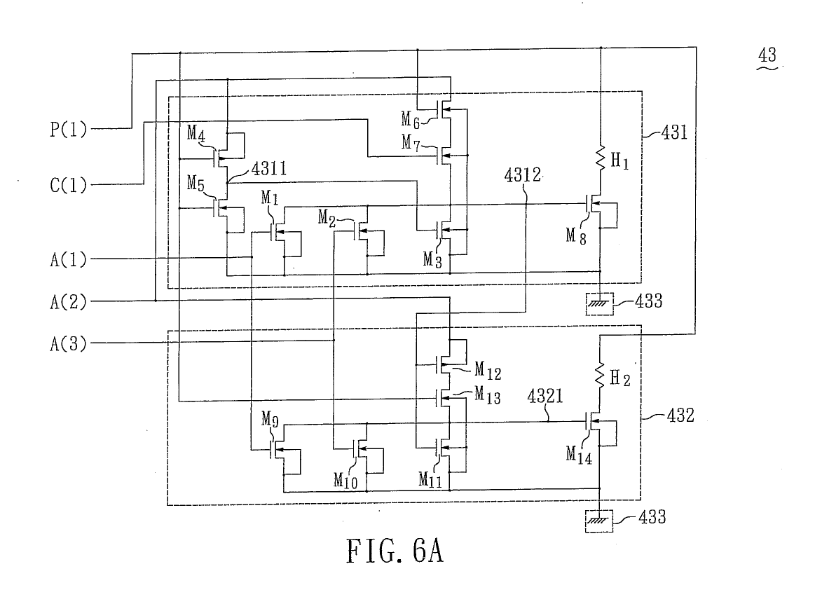

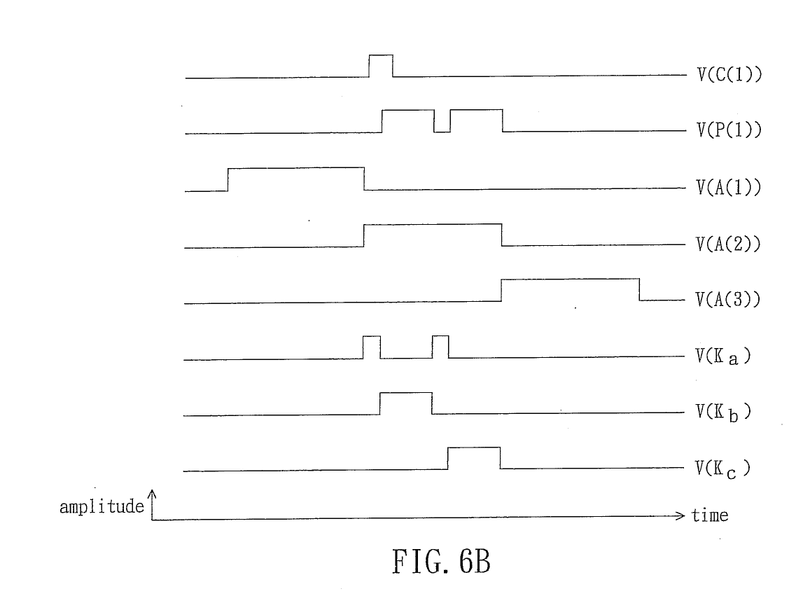

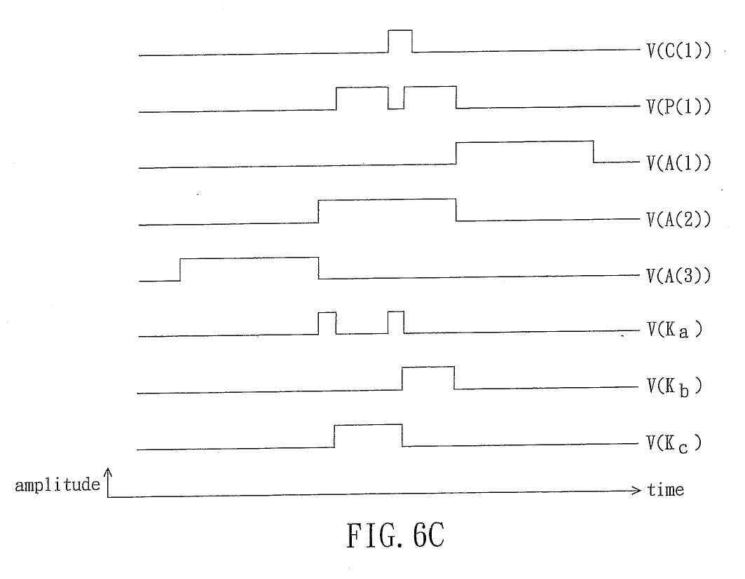

Please refer to FIG. 6A, which is a schematic view displaying the architecture of the internal circuit of the ink-jet unit set of FIG. 5. As shown in FIG. 6A, in the present embodiment, the first ink-jet unit 431 includes a first switch element M1˜an eighth switch element M8, and a first heating element H1, wherein the first switch element M1˜the third switch element M3, and the fifth switch element M5˜the eighth switch element M8 are preferably N-MOS switch elements, while the fourth switch element M4 is preferably a P-MOS switch element.

In the present embodiment, the base and the source of the first switch element M1 are connected with each other, and further connected with a ground terminal 433. The gate of the first switch element M1 receives the first address signal A(1) of the plurality of address signals. The base and the source of the second switch element M2 are connected with each other, and further connected with the ground terminal 433. The gate of the second switch element M2 receives the third address signal A(3) of the plurality of address signals. The base and the source of the third switch element M3 are connected with each other, and further connected with the ground terminal 433. The base and the drain of the fourth switch element M4 are connected with each other and receive the second address signal A(2) of the plurality of address signals. The gate of the fourth switch element M4 receives the voltage signal P(1). The base and the source of the fifth switch element M5 are connected with each other, and further connected with the ground terminal 433. The gate of the fifth switch element M5 receives the voltage signal P(1). The drain of the fifth switch element M5 and the source of the fourth switch element M4 are connected with each other at a first common connecting point 4311, wherein the first common connecting point 4311 is connected with the gate of the third switch element M3.

In the present embodiment, a reversed-directional element is consisted of the fourth switch element M4 and the fifth switch element M5, such as an inverter. The operation of the reversed-directional element is as following:

When the voltage signal P(1) received by the input terminal of the reversed-directional element, i.e. the connecting terminal of the gate of the fourth switch element M4 and the gate of the fifth switch element M5, is in the relative logic “High” state, i.e. V(P(1))=1, the fourth switch element M4 is in the Off-state, while the fifth switch element M5 is in the On-state. At this time, since the source of the fifth switch element M5 is connected with the ground terminal 433, the electric energy V(Ka) of the output terminal of the reversed-directional element, i.e. the first common connecting point 4311, will be decreased to the relative logic “Low” state, i.e. V(Ka)=0.

On the contrary, When the voltage signal P(1) received by the input terminal of the reversed-directional element is in the relative logic “Low” state, i.e. V(P(1))=0, the state of the fourth switch element M4, i.e. the On-state or the Off-state, is determined by the second address signal A(2) received by the drain thereof. That is, when the second address signal is in the relative logic “High” state, i.e. V(A(2))=1, the fourth switch element M4 is in the On-state. At this time, since the fifth switch element M5 is in the Off-state, the electric energy V(Ka) of the output terminal of the reversed-directional element, i.e. the first common connecting point 4311, will be increased to the relative logic “High” state, i.e. V(Ka)=1. As described above, when the input terminal of the reversed-directional element is in the relative logic “High” state, the output terminal of the reversed-directional element is in the relative logic “Low” state. Besides, when the input terminal of the reversed-directional element is in the relative logic “Low” state, the output terminal of the reversed-directional element is in the relative logic “High” state. These are the operation theories of the reversed-directional element. In the present embodiment, the output electric energy of the reversed-directional element is used to control the seventh switch element M7 to be in the On-state or in the Off-state.

The base of the sixth switch element M6 is connected with the base of the third switch element M3, wherein the gate and the drain of the sixth switch element M6 receive the voltage signal P(1) and the second address signal A(2), respectively. The base of the seventh switch element M7 is also connected with the base of the third switch element M3. The drain of the seventh switch element M7 is connected with the source of the sixth switch element M6. The gate of the seventh switch element M7 receives the selection signal C(1), for example, the control signal to drive the N-MOS switch element. The base and the source of the eighth switch element are connected with each other, and further connected with the ground terminal 433. The gate of the eighth switch element M8, the drain of the first switch element M1, the drain of the second switch element M2, the drain of the third switch element M3, and the source of the seventh switch element M7 are connected together at a second common connecting point 4312. Besides, one end of the first heating element H1 receives the voltage signal P(1), while the other end of the first heating element H1 is connected with the drain of the eighth switch element M8.

In the present embodiment, the second ink-jet unit 432 includes a ninth switch element M9˜an fourteenth switch element M14, and a second heating element H2, wherein the ninth switch element M9˜the eleventh switch element M11, and the thirteenth switch element M13˜the fourteenth switch element M14 are preferably N-MOS switch elements, while the twelfth switch element M12 is preferably a P-MOS switch element.

In the present embodiment, the base and the source of the ninth switch element M9 are connected with each other, and further connected with the ground terminal 433. The gate of the ninth switch element M9 receives the first address signal A(1). The base and the source of the tenth switch element M10 are connected with each other, and further connected with the ground terminal 433. The gate of the tenth switch element M10 receives the third address signal A(3). The base and the source of the eleventh switch element M11 are connected with each other, and further connected with the ground terminal 433. The gate of the eleventh switch element M11 is connected with the second common connecting point 4312 of the first ink-jet unit 431.

The base and the drain of the twelfth switch element M12 are connected with each other and receive the second address signal A(2). The gate of the twelfth switch element M12 is connected with the second common connecting point 4312 of the first ink-jet unit 431. The base of the thirteenth switch element M13 is connected with the base of the eleventh switch element M11. The drain of the thirteenth switch element M13 is connected with the source of the twelfth switch element M12. The gate of the thirteenth switch element M13 receives the voltage signal P(1). The base and the source of the fourteenth switch element M14 are connected with each other, and further connected with the ground terminal 433. The gate of the fourteenth switch element M14, the drain of the ninth switch element M9, the drain of the tenth switch element M10, the drain of the eleventh switch element M11, and the source of the thirteenth switch element M13 are connected together at a third common connecting point 4321. Besides, one end of the second heating element H2 receives the voltage signal P(1), while the other end of the second heating element H2 is connected with the drain of the fourteenth switch element M14.

Please refer to FIG. 6B, in accompany with FIG. 6A, wherein FIG. 6B is a schematic view displaying the timing diagram of the signals in the forward direction, when the electric circuit of the ink-jet unit set of FIG. 6A is operating. As shown in FIG. 6A and FIG. 6B, when the voltage signal P(1), the selection signal C(1) and the second address signal A(2) are in the relative logic “High” state, i.e. V(P(1))=1, V(C(1))=1, V(A(2))=1, the sixth switch element M6 and the seventh switch element M7 are both in the On-state. At the same time, the electric energy V(Kb) of the second common connecting point 4312 will raise to the electric potential of the second address signal A(2). Then, after passing through the sixth switch element M6 and the seventh switch element M7 in sequence, the second address signal A(2) makes the eighth switch element M8 to be in the On-state, too. Further, since the source of the eighth switch element M8 is connected with the ground terminal 433, the voltage signal P(1) selectively provides the electric energy to the first heating element H1, for selectively driving the first heating element H1 to execute the heating operation. For example, when the voltage signal P(1) is in the relative logic “High” state, i.e. V(P(1))=1, the voltage signal P(1) will drive the first heating element H1 to execute the heating operation, making the ink flowing through the first heating element H1 to be ink-jetted to a printing media, such as a paper, through the corresponding nozzle (not shown in the figure), for completing the ink-jetting operation.

In addition, since both of the second common connecting point 4312 and the second address signal A(2) are in the relative logic “High” state, the twelfth switch element M12 of the second ink-jet unit 432 is in the Off-state, making the fourteenth switch element M14 to be in the Off-state, too. As a result, the voltage signal P(1) cannot provide electric energy to the second heating element H2, making the second heating element H2 unable to be driven to execute the heating operation.

Moreover, when the selection signal C(1) is transformed to be in the relative logic “Low” state, i.e. V(C(1))=0, the seventh switch element M7 and the eighth switch element M8 are both in the Off-state. At this time, since the electric energy provided by the voltage signal P(1), to the first heating element Ht, cannot be grounded, the first heating element H1 will stop the execution of the heating operation.

Then, if the voltage signal P(1) is transformed to be in the relative logic “Low” state, i.e. V(P(1))=0, after passing the reversed-directional element, the electric energy V(Ka) of the first common connecting point 4311 is transformed to be in the relative logic “High” state, i.e. V(Ka)=1. Or, when either one of the first address signal A(1) and the third address signal A(3) to be in the relative logic “High” state, i.e. V(A(1))=1 or V(A(3))=1, the first switch element M1, the second switch element M2, or the third switch element M3 of the first ink-jet unit 431 will be in the On-state. Thus, the electric energy V(Kb) left on the second common connecting point 4312 will be transmitted to the ground terminal 433, through one of the first switch element M1, the second switch element M2, and the third switch element M3. As a result, the electric energy V(Kb) of the second common connecting point 4312 is decreased to 0 volt, and the eighth switch element M8 returns to its original state before the operation.

In the present embodiment, when the voltage signal P(1) is transformed to be in the relative logic “High” state again, the second address signal A(2) is maintained in the relative logic “High” state, and the selection signal C(1) is in the relative logic “Low” state (i.e. the second common connecting point 4312 is also in the relative logic “Low” state), i.e. when V(P(1))=1, V(A(2))=1, V(C(1))=0, (V(Kb)=0), the twelfth switch element M12 and the thirteenth switch element M13 are in the On-state. At this time, the electric energy V(Kc) of the third common connecting point 4321 will raise to the electric potential of the second address signal. A(2). Then, after passing through the twelfth switch element M12 and the thirteenth switch element M13 in sequence, the second address signal A(2) makes the fourteenth switch element M14 to be in the On-state, too. Further, since the source of the fourteenth switch element M14 is connected with the ground terminal 433, the voltage signal P(1) selectively provides the electric energy to the second heating element H2, for selectively driving the second heating element H2 to execute the heating operation, making the ink flowing through the second heating element H2 to be ink-jetted to a printing media, through the corresponding nozzle, for completing the ink-jetting operation.

In the present embodiment, due to the periodical characteristic of the output of the voltage signal P(1), the plurality of address signals A(1), A(2), and A(3), and the selection signal C(1), the electric circuit will repeat the above-mentioned operation periodically and execute the ink-jetting operation. As a result, when the first address signal A(1) or the third address signal A(3) is transformed to be in the relative logic “High” state again, i.e. V(A(1))=1 or V(A(3))=1, either one of the ninth switch element M9 or the tenth switch element M10 is in the On-state. Or, when the voltage signal P(1), the selection signal C(1), or the second address signal A(2) are transformed to be in the relative logic “High” state again, the electric energy V(Kb) of the second common connecting point 4312 is also in the relative logic “High” state, making the eleventh switch element M11 to be in the On-state. At this time, the electric energy V(Kc) left on the third common connecting point 4321 will be transmitted to the ground terminal 433, through one of the ninth switch element M9, the tenth switch element M10, and the eleventh switch element M11. As a result, the electric energy V(Kc) of the third common connecting point 4321 is decreased to 0 volt, and the fourteenth switch element M14 is in the Off-state, making the second heating element H2 unable to be driven to execute the heating operation. With the above-mentioned operation, it is confirmed that only one ink-jet unit, either one of the first ink-jet unit 431 and the second ink-jet unit 432, can execute the heating operation at a time.

As described above, the discharge operation of the first ink-jet unit 431 of the ink-jet unit set 43 of the present embodiment, is achieved through one of the first switch element M1, the second switch element M2, and the third switch element M3. Besides, the discharge operation of the second ink-jet unit 432 is achieved through one of the ninth switch element M9, the tenth switch element M10, and the eleventh switch element M11. In addition, the ink-jet unit set 43 of the present embodiment can selectively to control the first heating element H1 or the second heating element H2 to execute the heating operation, and further to execute the ink-jetting operation, with only the voltage signal P(1), the plurality of address signals A(1), A(2), and A(3), and the selection signal C(1).

Please refer to FIG. 6C, in accompany with FIG. 6A, wherein FIG. 6C is a schematic view displaying the timing diagram of the signals in the reversed direction, when the electric circuit of the ink-jet unit set of FIG. 6A is operating. As shown in FIG. 6A and FIG. 6C, the first ink-jet unit 431 and the second ink-jet unit 432 of the ink-jet unit set 43 selectively execute the ink-jetting operation, corresponding to the voltage signal P(1), the plurality of address signals A(1), A(2), and A(3), and the selection signal C(1). Since the ink-jetting operation here is similar to that described above and shown in FIG. 6B, the detailed description regarding the ink-jetting operation is omitted hereinafter. However, in the present embodiment, the timing sequence of the plurality of address signals A(1), A(2), and A(3), and the selection signal C(1) are opposite to those of the plurality of address signals A(1), A(2), and A(3), and the selection signal C(1) of FIG. 6B.

That is, when the ink-jet unit set 43 is in the forward printing status, i.e. when the plurality of address signals is in the relative logic “High” state, the plurality of address signals is output in the sequence of A(1), A(2), and A(3). Then, after the third address signal A(3) being output, the first address signal A(1) of the next cycle is output. In this way, the plurality of address signals is output sequentially and cyclically. As a result, the first ink-jet unit 431 executes the ink-jetting operation first. Then, the second ink-jet unit 432 executes the ink-jetting operation. On the contrary, when the ink-jet unit set 43 is in the reversed printing status, i.e. when the plurality of address signals is in the relative logic “High” state, the plurality of address signals is output in the sequence of A(3), A(2), and A(1). Then, after the first address signal A(1) being output, the third address signal A(3) of the next cycle is output. In this way, the plurality of address signals is output sequentially and cyclically. As a result, the second ink jet unit 432 executes the ink-jetting operation first. Then, the first ink-jet unit 431 executes the ink-jetting operation.

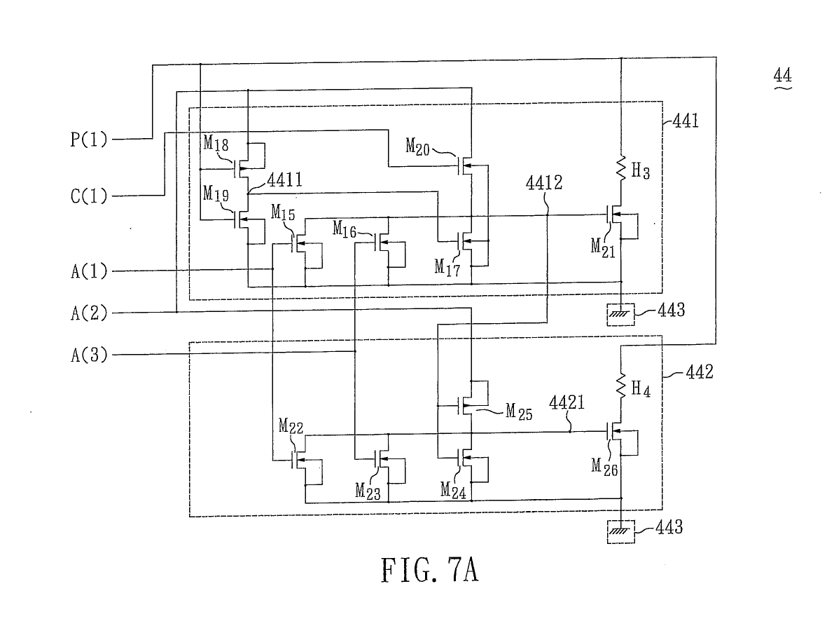

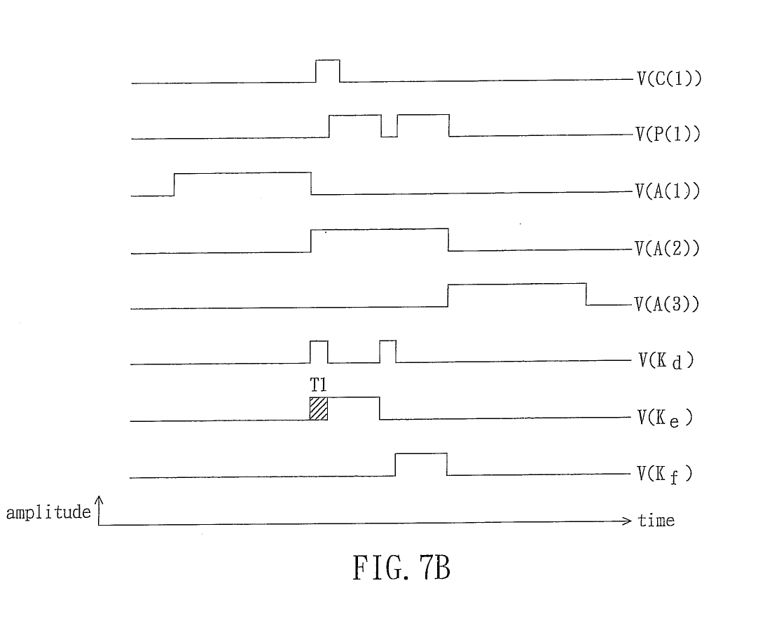

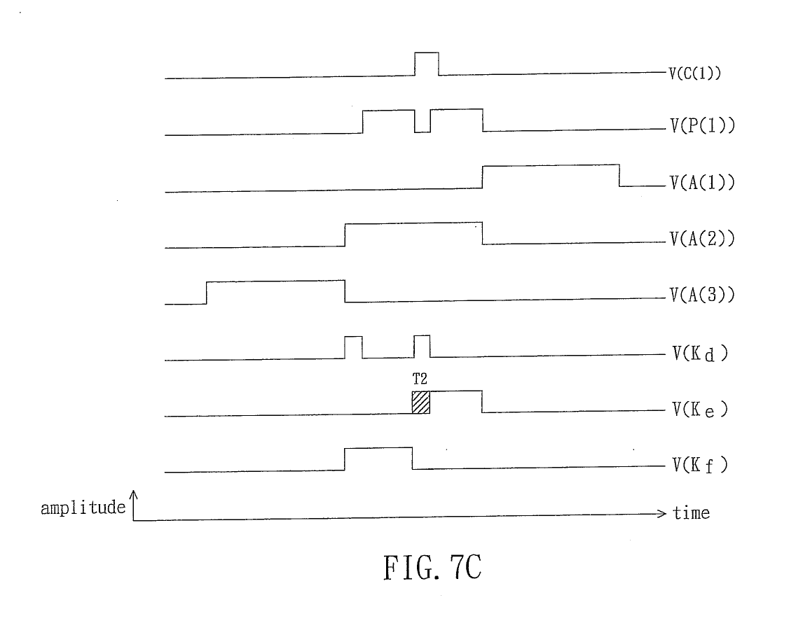

Please refer to FIG. 7A, which is a schematic view displaying the other architecture of the internal circuit of the ink-jet unit set of FIG. 5. As shown in FIG. 7A, in the present embodiment, the first ink-jet unit 441 includes a fifteenth switch element M15˜an twenty-first switch element M21, and a third heating element H3, wherein the fifteenth switch element M15˜the seventeenth switch element M17, and the nineteenth switch element M19 the twenty-first switch element M21 are preferably N-MOS switch elements, while the eighteenth switch element M18 is preferably a P-MOS switch element.

In the present embodiment, the base and the source of the fifteenth switch element M15 are connected with each other, and further connected with the ground terminal 443. The gate of the fifteenth switch element M15 receives the first address signal A(1) of the plurality of address signals. The base and the source of the sixteenth switch element M16 are connected with each other, and further connected with the ground terminal 443. The gate of the sixteenth switch element M16 receives the third address signal A(3) of the plurality of address signals. The base and the source of the seventeenth switch element M17 are connected with each other, and further connected with the ground terminal 443. The base and the drain of the eighteenth switch element M18 are connected with each other and receive the second address signal A(2) of the plurality of address signals. The gate of the eighteenth switch element M18 receives the voltage signal P(1). The base and the source of the nineteenth switch element M19 are connected with each other, and further connected with the ground terminal 443. The gate of the nineteenth switch element M19 receives the voltage signal P(1). The drain of the nineteenth switch element M19 and the source of the eighteenth switch element M18 are connected with each other at a fourth common connecting point 4411, wherein the fourth common connecting point 4411 is connected with the gate of the seventeenth switch element M17.

In the present embodiment, a reversed-directional element is consisted of the eighteenth switch element M18 and the nineteenth switch element M19, such as an inverter. Since the operation of the reversed-directional element is similar to that of the reversed-directional element consisted of the fourth switch element M4 and the fifth switch element M5, the detailed description regarding the reversed-directional element is omitted hereinafter. However, in the present embodiment, the electric energy output from the reversed-directional element is used to control the seventeenth switch element M17 to be in the On-state or in the Off-state.

The base of the twentieth switch element M20 is connected with the base of the seventeenth switch element M17, wherein the gate and the drain of the twentieth switch element M20 receive the selection signal C(1) and the second address signal A(2) of the plurality of address signals, respectively. The base and drain of the twenty-first switch element M21 are connected with each other, and further connected with the ground terminal 443. The gate of the twenty-first switch element M21, the drain of the fifteenth switch element M15, the drain of the sixteenth switch element M16, the drain of the seventeenth switch element M17, and the source of the twentieth switch element M20 are connected together at a fifth common connecting point 4412. Besides, one end of the third heating element H3 receives the voltage signal P(1), while the other end of the third heating element H3 is connected with the drain of the twenty-first switch element M21.

In the present embodiment, the voltage value of the fifth common connecting point 4412 at the T1 time of FIG. 7B and at the T2 time of FIG. 7C are respectively obtained from the voltage dividing of the internal resistor of the seventeenth switch element M17 and the internal resistor of the twentieth switch element M20. Since the internal resistor of the seventeenth switch element M17 is a high-impedance resistor, the electric energy V(Ke) of the fifth common connecting point 4412 is maintained in the relative logic “High” state, i.e. V(Ke)=1.

In the present embodiment, the second ink-jet unit 442 includes a twenty-second switch element M22˜an twenty-sixth switch element M26, and a fourth heating element H4, wherein the twenty-second switch element M22˜the twenty-fourth switch element M24, and the twenty-sixth switch element M26 are preferably N-MOS switch elements, while the twenty-fifth switch element M25 is preferably a P-MOS switch element.

In the present embodiment, the base and the source of the twenty-second switch element M22 are connected with each other, and further connected with the ground terminal 443. The gate of the twenty-second switch element M22 receives the first address signal A(1). The base and the source of the twenty-third switch element M23 are connected with each other, and further connected with the ground terminal 443. The gate of the twenty-third switch element M23 receives the third address signal A(3). The base and the source of the twenty-fourth element M24 are connected with each other, and further connected with the ground terminal 443. The gate of the twenty-fourth switch element M24 is connected with the fifth common connecting point 4412 of the first ink-jet unit 441.

The base and the drain of the twenty-fifth switch element M25 are connected with each other and receive the second address signal A(2). The gate of the twenty-fifth switch element M25 is connected with the fifth common connecting point 4412 of the first ink-jet unit 441. The base and the source of the twenty-sixth switch element 26 are connected with each other and further connected with the ground terminal 443. The gate of the twenty-sixth switch element M26, the drain of the twenty-second switch element M22, the drain of the twenty-third switch element M23, the drain of the twenty-fourth switch element M24, and the source of the twenty-fifth switch element M25 are connected together at a sixth common connecting point 4421. Besides, one end of the fourth heating element H4 receives the voltage signal P(1), while the other end of the fourth heating element H4 is connected with the drain of the twenty-sixth switch element M26.

Please refer to FIG. 7B, in accompany with FIG. 7A, wherein FIG. 7B is a schematic view displaying the timing diagram of the signals in the forward direction, when the electric circuit of the ink-jet unit set of FIG. 7A is operating. As shown in FIG. 7A and FIG. 7B, when the selection signal C(1) and the second address signal A(2) are in the relative logic “High” state, i.e. V(C(1))=1, V(A(2))=1, the twentieth switch element M20 is in the On-state. At the same time, the electric energy V(Ke) of the fifth common connecting point 4412 will raise to the electric potential of the second address signal A(2). Then, after passing through the twentieth switch element M20, the second address signal A(2) makes the twenty-first M21 to be in the On-state, too. Further, since the source of the twenty-first M21 is connected with the ground terminal 443, the voltage signal P(1) selectively provides the electric energy to the third heating element H3, for selectively driving the third heating element H3 to execute the heating operation, making the ink flowing through the third heating element H3 to be ink-jetted to a printing media, such as a paper, through the corresponding nozzle, for completing the ink-jetting operation.

In addition, since both of the fifth common connecting point 4412 and the second address signal A(2) are in the relative logic “High” state, the twenty-fifth switch element M25 of the second ink-jet unit 442 is in the Off-state, making the twenty-sixth switch element M26 to be in the Off-state, too. As a result, the voltage signal P(1) cannot provide electric energy to the fourth heating element H4, making the fourth heating element H4 unable to be driven to execute the heating operation.

Moreover, when the selection signal C(1) is transformed to be in the relative logic “Low” state, i.e. V(C(1))=0, the twentieth switch element M20 and the twenty-first switch element M21 are both in the Off-state. At this time, since the electric energy provided by the voltage signal P(1), to the third heating element H3, cannot be grounded, the third heating element H3 will stop the execution of the heating operation.

Then, if the voltage signal P(1) is transformed to be in the relative logic “Low” state, i.e. V(P(1))=0, after passing the reversed-directional element, the electric energy V(Kd) of the fourth common connecting point 4411 is transformed to be in the relative logic “High” state, i.e. V(Kd)=1. Or, when either one of the first address signal A(1) and the third address signal A(3) to be in the relative logic “High” state, i.e. V(A(1))=1 or V(A(3))=1, the fifteenth switch element M15, the sixteenth switch element M16, or the seventeenth switch element M17 of the first ink-jet unit 441 will be in the On-state. Thus, the electric energy V(Ke) left on the fifth common connecting point 4412 will be transmitted to the ground terminal 443, through one of the fifteenth switch element M15, the sixteenth switch element M16, or the seventeenth switch element M17. As a result, the electric energy V(Ke) of the fifth common connecting point 4412 is decreased to 0 volt, and the twenty-first switch element M21 returns to its original state before the operation.

In the present embodiment, when the second address signal A(2) is continuously in the relative logic “High” state again, and the selection signal C(1) is in the relative logic “Low” state (i.e. the fifth common connecting point 4412 is also in the relative logic “Low” state), i.e. when V(A(2))=1, V(C(1))=0, (V(Ke)=0), the twenty-fifth switch element M25 is in the On-state. At this time, the electric energy V(Kf) of the sixth common connecting point 4421 will raise to the electric potential of the second address signal A(2). Then, after passing through the twenty-fifth switch element M25, the second address signal A(2) makes the twenty-sixth switch element M26 to be in the On-state, too. Further, since the source of the twenty-sixth switch element M26 is connected with the ground terminal 443, the voltage signal P(1) selectively provides the electric energy to the fourth heating element H4, for selectively driving the fourth heating element H4 to execute the heating operation, making the ink flowing through the fourth heating element H4 to be ink-jetted to a printing media, through the corresponding nozzle, for completing the ink-jetting operation.

In the present embodiment, due to the periodical characteristic of the plurality of address signals A(1), A(2), and A(3), and the selection signal C(1), the electric circuit will repeat the above-mentioned operation periodically and execute the ink-jetting operation. As a result, when the first address signal A(1) or the third address signal A(3) is transformed to be in the relative logic “High” state again, i.e. V(A(1))=1 or V(A(3))=1, either one of the twenty-second switch element M22 or the twenty-third switch element M23 of the second ink-jet unit 442 is in the On-state. Or, when the selection signal C(1), or the second address signal A(2) are transformed to be in the relative logic “High” state again, the electric energy V(Ke) of the fifth common connecting point 4412 is also in the relative logic “High” state, making the twenty-fourth switch element M24 of the second ink-jet unit 442 to be in the On-state. At this time, the electric energy V(Kf) left on the sixth common connecting point 4421 will be transmitted to the ground terminal 443, through one of the twenty-second switch element M22, the twenty-third switch element M23, and the twenty-fourth switch element M24. As a result, the electric energy V(Kf) of the sixth common connecting point 4421 is decreased to 0 volt, and the twenty-sixth switch element M26 is in the Off-state, making the fourth heating element H4 unable to be driven to execute the heating operation. With the above-mentioned operation, it is confirmed that only one ink-jet unit, either one of the first ink-jet unit 441 and the second ink-jet unit 442, can execute the heating operation at a time.

As described above, the discharge operation of the first ink-jet unit 441 of the ink-jet unit set 44 of the present embodiment, is achieved through one of the fifteenth switch element M15, the sixteenth switch element M16, and the seventeenth switch element M17. Besides, the discharge operation of the second ink-jet unit 442 is achieved through one of the twenty-second switch element M22, the twenty-third switch element M23, and the twenty-fourth switch element M24. In addition, the ink-jet unit set 44 of the present embodiment can selectively to control the third heating element H3 or the fourth heating element H4 to execute the heating operation, and further to execute the ink-jetting operation, with only the voltage signal P(1), the plurality of address signals A(1), A(2), and A(3), and the selection signal C(1).

Please refer to FIG. 7C, in accompany with FIG. 7A, wherein FIG. 7C is a schematic view displaying the timing diagram of the signals in the reversed direction, when the electric circuit of the ink-jet unit set of FIG. 7A is operating. As shown in FIG. 7A and FIG. 7C, the first ink-jet unit 441 and the second ink-jet unit 442 of the ink-jet unit set 44 selectively execute the ink-jetting operation, corresponding to the voltage signal P(1), the plurality of address signals A(1), A(2), and A(3), and the selection signal C(1). Since the ink-jetting operation is similar to that described above and shown in FIG. 7B, the detailed description regarding the ink-jetting operation is omitted hereinafter. However, in the present embodiment, the timing sequence of the plurality of address signals A(1), A(2), and A(3), and the selection signal C(1) are opposite to those of the plurality of address signals A(1), A(2), and A(3), and the selection signal C(1) of FIG. 7B. That is, when the ink-jet unit set 44 is in the forward printing status, the first ink-jet unit 441 executes the ink-jetting operation first. Then, the second ink-jet unit 442 executes the ink-jetting operation. On the contrary, when the ink-jet unit set 44 is in the reversed printing status, the second ink-jet unit 442 executes the ink-jetting operation first. Then, the first ink-jet unit 441 executes the ink-jetting operation.

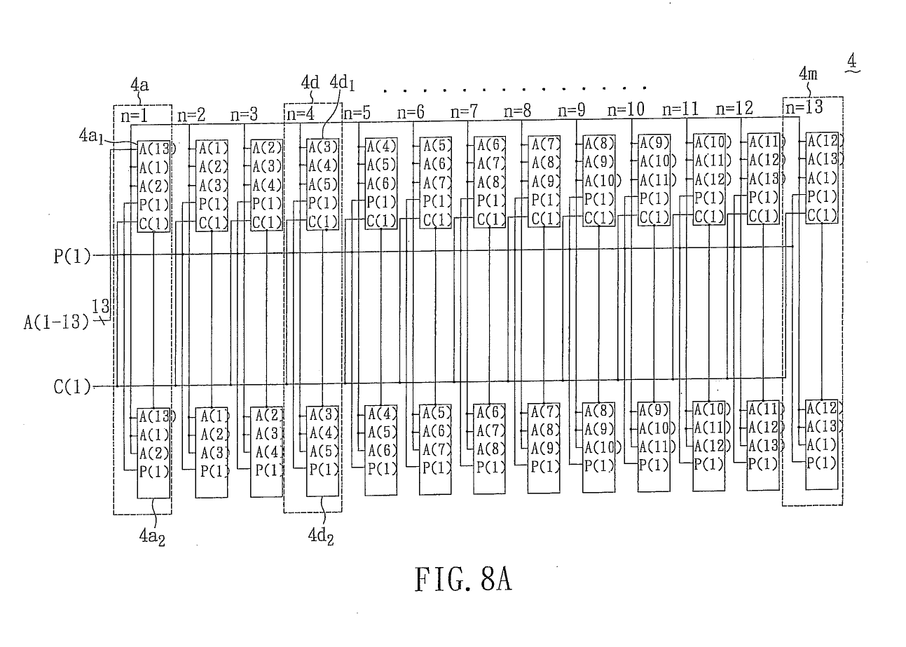

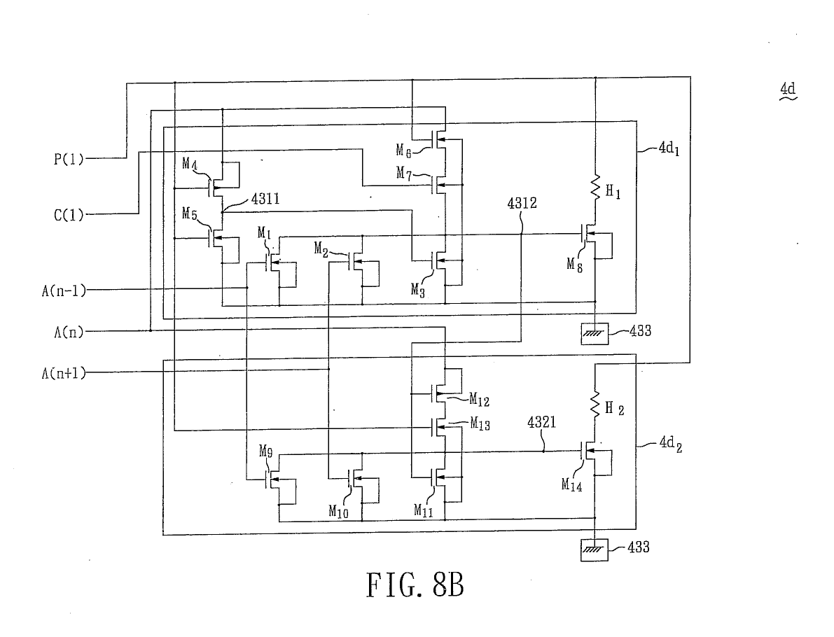

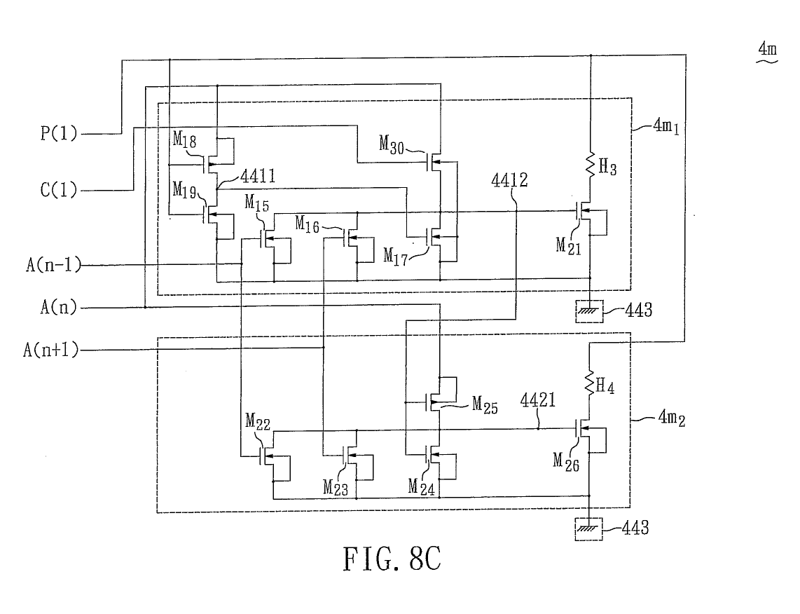

Please refer to FIG. 8A, FIG. 8B, and FIG. 8C, wherein FIG. 8A is a schematic view displaying the block diagram of the ink-jet array, according to one preferred embodiment of the present invention; FIG. 8B is a schematic view displaying the extended circuit architecture of FIG. 6A; and FIG. 8C is a schematic view displaying the extended circuit architecture of FIG. 7A. As shown in FIG. 8A, FIG. 8B, and FIG. 8C, the ink-jet array 4 includes a plurality of ink-jet unit sets, such as a first ink-jet unit set 4a˜a thirteenth ink-jet unit set 4m, wherein the architecture of the internal circuit of every ink-jet units of the plurality of ink jet unit sets 4a˜4m can be the circuit architecture shown in FIG. 8B or FIG. 8C. However, the architecture of the internal circuit of every ink-jet units of the plurality of ink-jet unit sets is not thus limited. The connection and the operation of these internal circuits are the same as those of the internal circuit described above, for example, the internal circuit shown in FIG. 6A or FIG. 7A. Thus, detailed description regarding the connection and the operation of these internal circuits are omitted hereinafter.

However, in the present embodiment, every ink-jet units of the plurality of ink-jet unit sets 4a˜4m receive a voltage signal P(1), and a first address signal A(1)˜a thirteenth address signal A(13) correspondingly and respectively. Besides, the first ink-jet unit 4a1˜4m1 of every ink-jet units of the plurality of ink-jet unit sets are used to receive the selection signal C(1), for controlling the plurality of ink-jet unit sets 4a˜4m to execute the heating operation. In the present embodiment, the ink-jet array 4 is installed on an ink-jet chip (not shown in the figure). In some embodiments, the ink-jet chip may install a plurality of ink-jet array thereon, for improving the printing resolution and increasing the printing speed.

The ink-jet unit set shown in FIG. 8B is one of the plurality of ink-jet unit sets 4a˜4m. For example, at the timing sequence n=4, the ink-jet unit set is the fourth ink-jet unit set 4d, The fourth ink-jet unit set 4d includes a first ink-jet unit 4d1 and a second ink-jet unit 4d2. The first ink-jet unit 4d1 includes a first switch element M1˜a eighth switch element M8, and a first heating element H1. The second ink-jet unit 4d2 includes a ninth switch element M9˜a fourteenth switch element M14, and a second heating element H2. The connection and the operation of these switch elements and heating elements are the same as those of the switch elements and heating elements shown in FIG. 6A. Thus, detailed description regarding the connection and the operation of these switch elements and heating elements are omitted hereinafter. However, in the present embodiment, at the timing sequence n=4, the first ink-jet unit 4d1 receives the voltage signal P(1) and the plurality of address signals A(n−1), A(n), and A(n+1), i.e. the third address signal A(3), the fourth address signal A(4), and the fifth address signal A(5), and the selection signal C(1). Besides, the second ink-jet unit 4d2 receives the voltage signal P(1) and the plurality of address signals A(3), A(4), and A(5). Wherein, when the selection signal C(1) is in the enable state, for example, in the relative logic “High” state, the first ink-jet unit 4d1 executes the heating operation, in response to the voltage signal P(1), and the plurality of address signals A(3), A(4), and A(5). On the contrary, when the selection signal C(1) is in the disable state, for example, in the relative logic “Low” state, the second ink-jet unit 4d2 executes the heating operation, in response to the voltage signal P(1), and the plurality of address signals A(3), A(4), and A(5).

In same manner, the ink-jet unit set shown in FIG. 8C is also one of the plurality of ink-jet unit sets 4a˜4m. For example, at the timing sequence n=13, the ink-jet unit set is the thirteenth ink-jet unit set 4m, The thirteenth ink-jet unit set 4m includes a first ink-jet unit 4m1 and a second ink-jet unit 4m2. The first ink-jet unit 4m1 includes a fifteenth switch element M15˜a twenty-first switch element M21, and a third heating element H3. The second ink-jet unit 4m2 includes a twenty-second switch element M22˜a twenty-sixth switch element M26, and a fourth heating element H4. The connection and the operation of these switch elements and heating elements are the same as those of the switch elements and heating elements shown in FIG. 7A. Thus, detailed description regarding the connection and the operation of these switch elements and heating elements are omitted hereinafter. However, in the present embodiment, at the timing sequence n=13, the first ink-jet unit 4m1 receives the voltage signal P(1) and the plurality of address signals A(n−1), A(n), and A(n+1), i.e. the twelfth address signal A(12), the thirteenth address signal A(13), and the first address signal A(1), and the selection signal C(1). Besides, the second ink-jet unit 4m2 receives the voltage signal P(1) and the plurality of address signals A(12), A(13), and A(1). Wherein, when the selection signal C(1) is in the enable state, the first ink-jet unit 4m1 executes the heating operation, in response to the voltage signal P(1), and the plurality of address signals A(12), A(13), and A(1). On the contrary, when the selection signal C(1) is in the disable state, the second ink-jet unit 4m2 executes the heating operation, in response to the voltage signal P(1), and the plurality of address signals A(12), A(13), and A(1).

In some embodiments, the ink-jet array 4 can receive N address signals A, wherein N is an integer, for example but not limited to N=16. That is, the ink-jet array 4 can receive 16 address signals, and the timing sequence can be n=1˜n=16. Thus, at the timing sequence n=1, the plurality of address signals includes A(n−1)=16, A(n)=1, and A(n+1)=2. At the timing sequence n=16, the plurality of address signals includes A(n−1)=15, A(n)=16, and A(n+1)=1. In this way, every ink-jet unit sets of the ink-jet array 4 can be controlled to execute the heating operation.

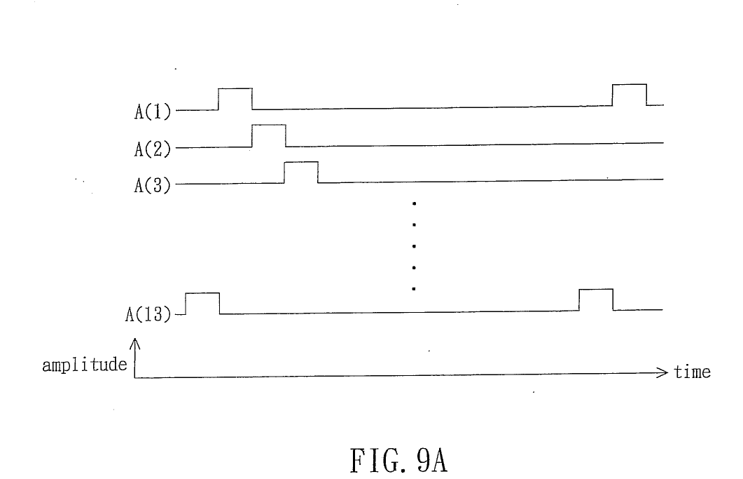

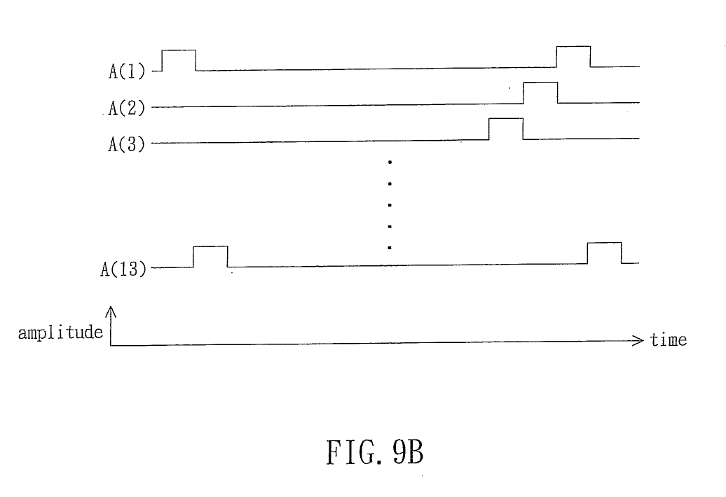

Please refer to FIG. 9A and FIG. 9B, wherein FIG. 9A is a schematic view displaying the timing diagram of the address signals in the first printing direction according to one embodiment of the present invention; and FIG. 9B is a schematic view displaying the timing diagram of the address signals in the second printing direction according to one embodiment of the present invention. As shown in FIG. 9A and FIG. 9B, the first printing direction is the forward printing direction. The plurality of address signals is in the relative logic “High” state, and the plurality of address signals is output in the sequence of A(1), A(2), . . . , A(13). Then, after the thirteenth address signal A(13) being output, the first address signal A(1) of the next cycle is output. In this way, the plurality of address signals is output sequentially and cyclically. On the contrary, in the second printing direction, i.e. the reversed printing direction, the plurality of address signals is in the relative logic “High” state. The plurality of address signals is output in the sequence of A(13), A(12), . . . , A(1). Then, after the first address signal A(1) being output, the thirteenth address signal A(13) of the next cycle is output. In this way, the plurality of address signals is output sequentially and cyclically. As a result, the ink-jet head (not shown in the figure) can execute the bi-directional printing operation.

Besides, the mechanism of the bi-directional printing operation uses the previous address signal A(n−1), and the next address signal A(n+1) to achieve the discharge purpose, and making the driven switch element to return to its original state before the operation.

By arranging the heaters interleavingly on the ink-jet chip, more heaters can be installed on the ink-jet chip of the ink-jet head of the present invention. Thus, the space of the ink-jet head can be used effectively, the cost of the ink-jet head can be lowered, and the printing speed of the ink-jet head can be increased. In addition, by simplifying the address controlling process of the internal chip of the ink-jet head, the area of the wiring region of the ink-jet chip can be decreased, making the area of the wiring region to be 75%˜61% of the total area region of the ink-jet chip, as the best embodiment, such as the ink-jet chip applied in a single-color or multi-colors ink-jet head having multiple tanks. Besides, in the case of the single-color or bi-colors ink-jet chip, where the ink is respectively introduced from the bi-tanks and through the ink supply passages, the area of the wiring region is 75%˜61% of the total area region of the ink-jet chip, as the best embodiment. In addition, in the case of the single-color or tri-colors ink-jet chip, where the ink is respectively introduced from the tri-tanks and through the ink supply passages, the area of the wiring region is 72%˜62% of the total area region of the ink-jet chip, as the best embodiment. At last, in the case of the single-color ink-jet chip, where the ink is introduced from the mono-tank and through the ink supply passage, the area of the wiring region is 80%˜63% of the total area region of the ink-jet chip, as the best embodiment. In this way, the size of the ink jet head can be minimized, resulting in the decreasing of the manufacturing cost of the ink-jet printer.

Although the present invention has been explained in relation to its preferred embodiment, it is to be understood that many other possible modifications and variations can be made without departing from the spirit and scope of the invention as hereinafter claimed.

What is claimed is:

1. An ink-jet head, adaptive for an ink cartridge including two ink tanks, the ink-jet head includes:
a nozzle board, having a plurality of nozzles; and
an ink-jet chip, being used for controlling the ink-jetting and having a total area region consisting of a length and a width, wherein the total area region includes:
a non-wiring region, where two ink flow channels being installed therein; and
a wiring region, where an internal circuit being installed therein; wherein the internal circuit includes a plurality of ink-jet unit sets, and every ink-jet units of the plurality of ink-jet unit sets include a heater installed correspondingly to the nozzle;
wherein the area of the wiring region of the ink-jet chip is less than 77% of the area of the total area region of the ink-jet chip.

2. The ink-jet head as claimed in claim 1, wherein the area of the wiring region of the ink-jet chip is preferably 75 to 61% of the area of the total area region of the ink-jet chip.

3. The ink-jet head as claimed in claim 1, wherein the aspect ratio of the ink-jet chip is between 11 and 20.

4. The ink-jet head as claimed in claim 1, wherein the width of the ink-jet chip is between 1.27 and 2.31 millimeter.

5. The ink-jet head as claimed in claim 1, wherein the length of the ink-jet chip is 25.4 millimeter.

6. The ink-jet head as claimed in claim 1, wherein the maximum of the area of the ink-jet chip is 58.67 square millimeters.

7. The ink-jet head as claimed in claim 1, wherein the ink-jet chip includes at least 750 heaters.

8. The ink-jet head as claimed in claim 1, wherein the number of the heaters is 13 to 23 per square millimeters, and the heaters are arranged to form at least one axis.

9. The ink-jet head as claimed in claim 1, wherein the aspect ratio of the ink jet chip is between 6 and 20.

10. The ink jet head as claimed in claim 1, wherein the width of the ink-jet chip is between 1.32 and 4.5 millimeter.

11. The ink-jet head as claimed in claim 1, wherein the length of the ink-jet chip is 26.5 millimeter.

12. The ink-jet head as claimed in claim 1, wherein the area of the total area region of the ink-jet chip is between 34.45 and 119.25 square millimeters.

13. The ink-jet head as claimed in claim 1, wherein the ink-jet chip includes at least 4500 to 6000 heaters.

14. The ink-jet head as claimed in claim 1, wherein the number of the heaters is 38 to 170 per square millimeters, and the heaters are arranged to form at least one axis.

15. An ink-jet head, adaptive for an ink cartridge including two ink tanks, the ink jet head includes:
a nozzle board, having a plurality of nozzles; and
an ink-jet chip, being used for controlling the ink-jetting and having a total area region consisting of a length and a width, wherein the total area region includes:
a non-wiring region, where two ink flow channels being installed therein; and
a wiring region, where an internal circuit being installed therein; wherein the internal circuit includes a plurality of ink-jet unit sets, and every ink-jet units of the plurality of ink-jet unit sets include a heater installed correspondingly to the nozzle; each of the plurality of ink jet unit sets includes:
a first ink-jet unit, for receiving a voltage signal, a plurality of address signals, and a selection signal; and
a second ink-jet unit, for receiving the voltage signal and the plurality of address signals; when the selection signal is in the enable state, the first ink-jet unit enables the heater thereof to execute the heating operation, corresponding to the voltage signal and the plurality of address signals; when the selection signal is in the disable state, the second ink-jet unit enables the heater thereof to execute the heating operation, corresponding to the voltage signal and the plurality of address signals;
wherein the area of the wiring region of the ink-jet chip is less than 77% of the area of the total area region of the ink-jet chip.

16. The ink-jet head as claimed in claim 15, wherein the area of the wiring region of the ink-jet chip is preferably 75 to 61% of the area of the total area region of the ink-jet chip.
